(19) United States
(12) Patent Application Publication
(10) Pub. No.: US 2013/0102272 A1
(43) Pub. Date: Apr. 25, 2013

(54) SYSTEM AND METHOD FOR DETERMINING A WIRELESS ACCESS LOCALE FOR PLACING A WIRELESS CALL

(71) Applicants: Timothy L. Auen, Thornton, CO (US); John Lawrence Snapp, Westminster, CO (US)

(72) Inventors: Timothy L. Auen, Thornton, CO (US); John Lawrence Snapp, Westminster, CO (US)

(73) Assignee: WEST CORPORATION, Omaha, NE (US)

(21) Appl. No.: 13/277,490

(22) Filed: Oct. 20, 2011

(51) Int. Cl. H04W 4/22; H04W 4/02

(52) U.S. Cl. 455/404.2; 455/456.1

(57) ABSTRACT

A system for determining location for an access locale for wireless calls using a wireless communicator; the system including: (a) a sensor coupled with the wireless communicator for sensing strength of wireless access signals detected by the wireless communicator; (b) a locator coupled with at least one of the sensor and the wireless communicator for indicating location of the wireless communicator while detecting the wireless access signal; (c) a data store coupled with at least one of the sensor, the wireless communicator and the locator for storing at least signal strength information from the sensor and location information from the locator for wireless access signals detected by the wireless communicator; and (d) a mapper coupled with at least one of the data store and the wireless communicator. The mapper cooperating with the data store and the wireless communicator to indicate direction toward a wireless access signal.

### FIELD OF THE INVENTION

The present invention is directed to telecommunication systems, and especially to handling wireless emergency service calls in geographical areas having sparse wireless coverage.

### BACKGROUND OF THE INVENTION

Users of wireless communication devices may unknowingly enter geographic areas having little or no wireless access, known as sparse coverage areas. If a user in such a sparse coverage area finds himself in an emergency situation such as, by way of example and not by way of limitation, an accompanying traveler experiences a heart attack, it would be desirable for the user to be able to determine in which direction he may proceed in order to have wireless access available as soon as possible.

There is a need for a system and method for determining a locale for wireless access for placing a wireless call.

There is a need for a system and method for determining a locale for wireless access for placing a wireless emergency service call.

### SUMMARY OF THE INVENTION

A system for determining an access locale for wireless calls using a wireless communicator; the system including: (a) a sensor coupled with the wireless communicator for sensing strength of wireless access signals detected by the wireless communicator; (b) a locator coupled with at least one of the sensor and the wireless communicator for indicating location of the wireless communicator while detecting the wireless access signal; (c) a data store coupled with at least one of the sensor, the wireless communicator and the locator for storing at least signal strength information from the sensor and location information from the locator for wireless access signals detected by the wireless communicator; and (d) a mapper coupled with at least one of the data store and the wireless communicator. The mapper cooperating with the data store and the wireless communicator to indicate direction toward a wireless access signal.

A method for determining a wireless access locale for placing a wireless call using a wireless communication device; the method including: (a) in no particular order: (1) providing a signal sensing unit coupled with the wireless communication device for sensing strength of at least one wireless access signal detected by the wireless communication device; (2) providing a location indicating unit coupled with at least one of the signal sensing unit and the wireless communication device for indicating location of the wireless communication device while the wireless communication device is detecting the at least one wireless access signal; (3) providing at least one data store coupled with at least one of the signal sensing unit, the wireless communication device and the location indicating unit for storing at least signal strength information from the signal sensing unit and location indicating information from the location indicating unit for the at least one wireless access signal detected by the wireless communication device; and (4) providing a mapping unit coupled with at least one of the data store and the wireless communication device; and (b) operating the mapping unit cooperatively with the data store and the wireless communication device to indicate to a user of the wireless communication device at least one direction toward at least one respective wireless access signal of the at least one wireless access signal for effecting wireless communication.

It is, therefore a feature of the present invention to provide a system and method for determining a locale for wireless access for placing a wireless call.

It is another feature of the present invention to provide a system and method for determining a locale for wireless access for placing a wireless emergency service call.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a representative map of a geographical area in which the problem sought to be remedied by the present invention may be encountered.

FIG. 2 is a schematic diagram of a system for determining a locale for wireless access locale for placing a wireless call such as an emergency service call.

FIG. 3 is a flow diagram illustrating a method for determining a locale for wireless access locale for placing a wireless call such as an emergency service call.

### DETAILED DESCRIPTION

For purposes of illustration, by way of example and not by way of limitation, the present invention will be discussed in the context of an emergency service network in the United States, commonly referred to as an E9-1-1 network. The teachings of the present invention are equally applicable, useful and novel in other special number calling systems, such as maintenance service networks, college campus security networks and other networks.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

When the terms “coupled” and “connected”, along with their derivatives, are used herein, it should be understood that these terms are not intended as synonyms for each other. Rather, in particular embodiments, “connected” is used to indicate that two or more elements are in direct physical or electrical contact with each other. “Coupled” is used to indicated that two or more elements are in either direct or indirect (with other intervening elements between them) physical or electrical contact with each other, or that the two or more elements co-operate or interact with each other (e.g., as in a cause-and-effect relationship).

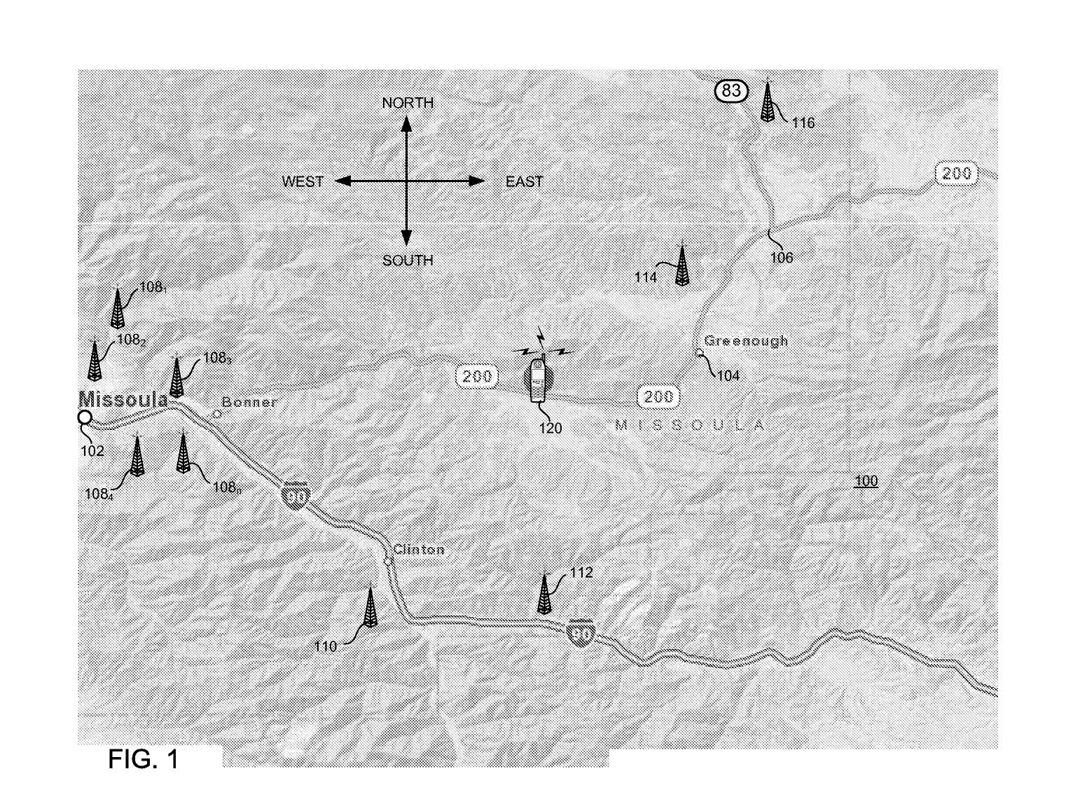

FIG. 1 is a representative map of a geographical area in which the problem sought to be remedied by the present invention may be encountered. In FIG. 1, a representative geographical area 100 in the vicinity of Missoula, Mont. 102 is presented. From Missoula 102 a highway #200 proceeds generally East to the vicinity of a town Greenough 104. From Greenough 104, highway #200 proceeds generally in a Northeast direction past an intersection 106 with a highway #83 heading generally North from intersection 106. An Interstate Highway #90 proceeds generally Southeast from Missoula 102.

Mobile phone service coverage is substantially thoroughly established in the vicinity of Missoula 102 by presence of mobile phone towers 108₁, 108₂, 108₃, 108₄, 108_{g}. The indicator “n” is employed to signify that there can be any number of mobile phone towers in the vicinity of Missoula 102. The inclusion of five mobile phone towers 108₁, 108₂, 108₃, 108₄, 108ₙ in FIG. 1 is illustrative only and does not constitute any limitation regarding the number of mobile phone towers that may be included in the vicinity of Missoula 102 when employing the present invention. Throughout this description, use of a reference numeral using a generic subscript herein may be taken to mean that any respective member of the plurality of elements having the same reference numeral may be regarded as included in the description. Thus, by way of example and not by way of limitation, referring to mobile phone tower 108ₙ in describing FIG. 1 may be taken to mean that any mobile phone tower—108₁, 108₂, 108₃, 108₄, 108ₙ (FIG. 1)—may be regarded as capable of employment as described.

One may observe that mobile phone service coverage is less thoroughly established as one proceeds Southeast on Interstate Highway #90 from the vicinity of Missoula 102 by presence of mobile phone towers 110, 112 along Interstate Highway #90 in a pattern having less density than density established by mobile phone towers 108ₙ. Mobile phone service coverage is even less thoroughly established as one proceeds East along highway #200 as the single mobile phone tower 114 is substantially alone in the area of Greenough 104. Mobile phone service coverage is also less thoroughly or more sparsely established as one proceeds North from highway #200 along highway #83 as a single mobile phone tower 116 is substantially alone in the area North of highway #83.

If, by way of example and not by way of limitation, one travels

East from Missoula 102 along highway #200 and reaches a locus 120, one may have been losing signal strength from mobile phone towers 108ₙ over time as distance from Missoula 102 increased and not realized a gradual loss of mobile phone coverage. One at locus 120 may be too far for detectable mobile phone coverage using mobile phone towers 110, 112, 114, 116. If one experiences an emergency at locus 120, for example, there would be a need for information relating to which way one should proceed to regain mobile phone coverage in the least amount of travel time that may be required. This dilemma and need for information is a problem that is addressed by the present invention.

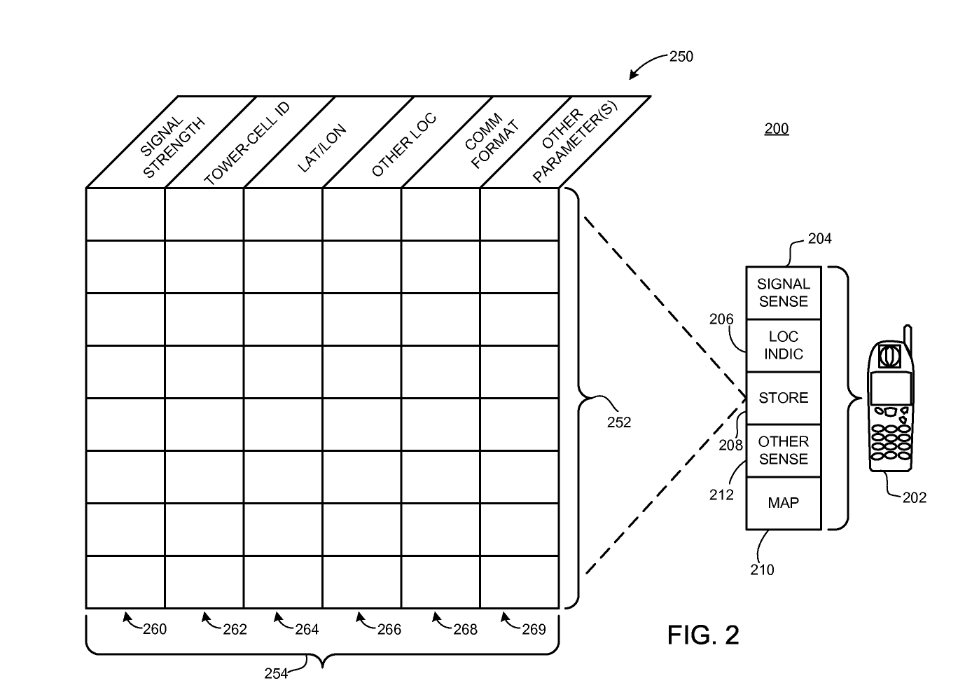

FIG. 2 is a schematic diagram of a system for determining a wireless access locale for placing a wireless call such as an emergency service call. In FIG. 2, a locale determining system 200 is configured and coupled for use with a wireless communication device 202. System 200 includes a signal sensing unit or sensor 204 coupled with wireless communication device 202. Signal sensing unit 204 is configured for sensing strength of at least one wireless access signal detected by wireless communication device 202 from a mobile phone tower (e.g., mobile phone towers 108ₙ; FIG. 1).

System 200 also includes a location indicating device or locator 206 coupled with at least one of signal sensing unit 204 and wireless communication device 202. Location indicating device 206 is coupled and configured for indicating location of wireless communication device 202 while wireless communication device 202 is detecting at least one wireless access signal. Location indicating device 206 may employ any location indication technology including, but not limited to, Global Positioning Satellite (GPS) location technology, cell-tower-and-cell location technology or other location technologies. Location indication may be expressed by location indicating device 206 in terms of one or more of latitude-longitude (LAT/LON), GPS coordinates or another location indication.

System 200 also includes at least one data store 208 coupled with at least one of signal sensing unit 204, wireless communication device 202 and location indicating device 206. At least one data store 208 is coupled and configured for storing at least signal strength information received from signal sensing unit 204 and location indicating information received from location indicating device 206 for the at least one wireless access signal detected by wireless communication device 202.

System 200 also includes a mapping unit or mapper 210 coupled with at least one of at least one data store 208 and wireless communication device 22. Mapping unit 210 is coupled and configured to indicate at least one direction toward at least one respective wireless access signal for effecting wireless communication using wireless communication device 202. Mapping unit 210 may also indicate a respective distance to each of the indicated respective wireless signal coverage areas.

System 200 may also include an other sensing unit 212 for sensing other parameters than signal strength related to wireless access signal detected by wireless communication device 202. By way of example and not by way of limitation, one such other parameter may be the communication format employed by each respective wireless access signal. Examples of such communication formats may include, by way of example and not by way of limitation, the respective wireless service provider providing a particular signal, the technology involved in presenting the wireless access signal (e.g., Time Division Multiple Access (TDMA) technology, Code Division Multiple Access (CDMA) technology, Wireless Fidelity (WiFi) technology or another technology) or another characteristic of the received wireless access signal.

Data store 208 (at least one data store 208 will be hereinafter referred to as “data store 208” for simplicity's sake; one must keep in mind that more than one data store may comprise data store 208) may be configured, by way of example and not by way of limitation in the form of a table 250, as illustrated in FIG. 2. Table 250 may include a plurality of rows 252 arranged in a plurality of columns 254. Columns 254 may arrange information entries for respective received wireless access signals arrayed in rows 252. By way of example and not by way of limitation, information entries arranged in columns 254 may include signal strength (Column 260), tower-cell identification (Column 262), LAT/LON (Column 264), Other Location indication (OTHER LOC; Column 266), communication format (Column 268) and other parameters (Column 269) for each received wireless access signal received by wireless communication device 202.

Information stored in data store 208 may be amassed and stored in data store 208 as wireless communication device 202 is used, such as by way of example and not by way of limitation, as wireless communication device 202 proceeds East along highway #200 (FIG. 1). Alternatively, information stored in data store 208 may be downloaded to wireless communication device 202 (1) when wireless communication device 202 initially signs on for a extant communication session (2) periodically during an extant communication session, or (3) on demand by a user of wireless communication device 202. Any combination of those three enumerated examples may be an approach for downloading information to data store 208. Yet another example of how data store 208 may amass information for storage is for system 200 to collect information as wireless communication device 202 travels about a geographic area, such as when a wireless communication device 202 is carried about by a user who may commute from Greenough 104 to Missoula 102 (FIG. 1). Such information may be date-stamped or otherwise dated and only information most recently stored may be retained by data store 208. That is to say, data store 208 may periodically update its stored information to erase or otherwise eliminate older data from data store 208. System 200 may establish a minimum signal strength (or another parameter) below which information will not be stores. By way of example and not by way of limitation, such a minimum signal strength may be related to a signal strength below which reliable wireless communications cannot be carried out.

System 200 may employ information stored in data store 208 in cooperation with at least one of mapping unit 210 and wireless communication device 220 to advise a user of a direction or a direction and a distance to a mobile communication access locale at which a wireless call (such as an emergency service wireless call) may be placed. In many cases, the recommendation presented to a user may be the last-experienced wireless access locale recorded by system 200. In the example presented in FIG. 1 that recommended locale may be found in the direction of Missoula 102 from locus 120. In the case of the above-related commuter example (because of earlier travel to an area not yet traveled that day) or when information is downloaded relating to an area not yet traveled that day, data store 208 may have information available to support advising a user of wireless communication device 202 at locus 120 that wireless access may be gained sooner by driving toward Greenough 104 from locus 120 rather than toward Missoula 102.

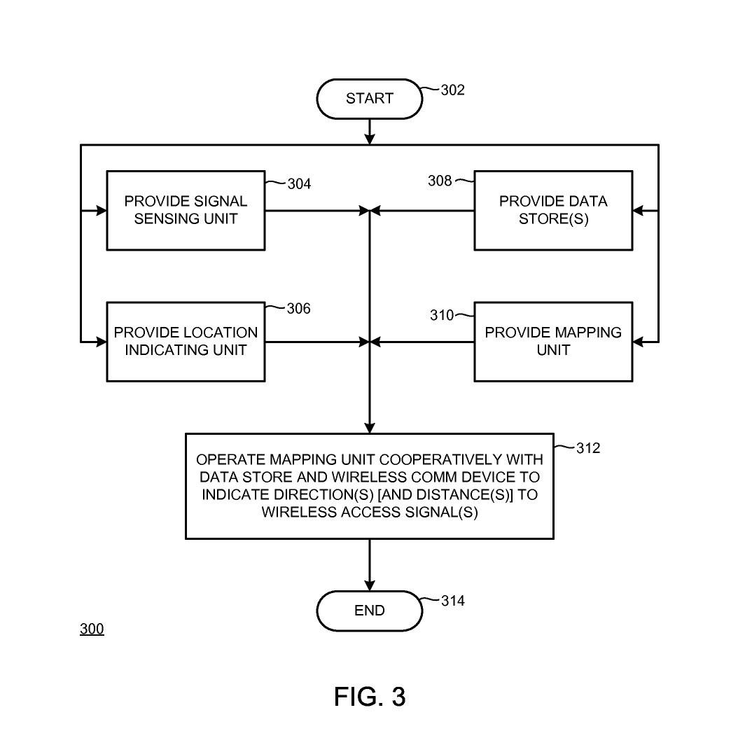

FIG. 3 is a flow diagram illustrating a method for determining a wireless access locale for placing a wireless call such as an emergency service call. In FIG. 3, a method 300 for determining a wireless access locale for placing a wireless call using a wireless communication device begins at a START locus 30.

Method 300 continues with, in no particular order: (1) providing a signal sensing unit coupled with the wireless communication device for sensing strength of at least one wireless access signal detected by the wireless communication device, as represented by a block 304; (2) providing a location indicating unit coupled with at least one of the signal sensing unit and the wireless communication device for indicating location of the wireless communication device while the wireless communication device is detecting the at least one wireless access signal, as represented by a block 306; (3) providing at least one data store coupled with at least one of the signal sensing unit, the wireless communication device and the location indicating unit for storing at least signal strength information from the signal sensing unit and location indicating information from the location indicating unit for the at least one wireless access signal detected by the wireless communication device, as represented by a block 308; and (4) providing a mapping unit coupled with at least one of the data store and the wireless communication device, as represented by a block 310.

Method 300 continues with operating the mapping unit cooperatively with the data store and the wireless communication device to indicate to a user of the wireless communication device at least one direction toward at least one respective wireless access signal of the at least one wireless access signal for effecting wireless communication, as represented by a block 312. Method 300 terminates at an END locus 314.

It is to be understood that, while the detailed drawings and specific examples given describe embodiments of the invention, they are for the purpose of illustration only, that the system and method of the invention are not limited to the precise details and conditions disclosed and that various changes may be made therein without departing from the spirit of the invention which is defined by the following claims:

1. A system for determining a wireless access locale for placing a wireless call using a wireless communication device; the system comprising:
(a) a signal sensing unit coupled with said wireless communication device for sensing strength of at least one wireless access signal detected by said wireless communication device;
(b) a location indicating unit coupled with at least one of said signal sensing unit and said wireless communication device for indicating location of said wireless communication device while said wireless communication device is detecting said at least one wireless access signal;
(c) at least one data store coupled with at least one of said signal sensing unit, said wireless communication device and said location indicating unit for storing at least signal strength information from said signal sensing unit and location indicating information from said location indicating unit for said at least one wireless access signal detected by said wireless communication device; and
(d) a mapping unit coupled with at least one of said data store and said wireless communication device; said mapping unit cooperating with said data store and said wireless communication device to indicate to a user of said wireless communication device at least one direction toward at least one respective wireless access signal of said at least one wireless access signal for effecting wireless communication.

2. The system for determining a wireless access locale for placing a wireless call using a wireless communication device as recited in claim 1 wherein said mapping unit indicates direction and distance to each said at least one respective wireless access signal.

3. The system for determining a wireless access locale for placing a wireless call using a wireless communication device as recited in claim 1 wherein said at least one data store also stores facilities location information regarding cellular towers and cell boundaries within a predetermined range of said wireless communication device.

4. The system for determining a wireless access locale for placing a wireless call using a wireless communication device as recited in claim 3 wherein said facilities location information is downloaded to said at least one data store via said wireless communication device.

5. The system for determining a wireless access locale for placing a wireless call using a wireless communication device as recited in claim 1 wherein said at least one data store also stores information relating to communication format accommodated by each said at least one wireless access signal.

6. The system for determining a wireless access locale for placing a wireless call using a wireless communication device as recited in claim 2 wherein said at least one data store also stores facilities location information regarding cellular towers and cell boundaries within a predetermined range of said wireless communication device.

7. The system for determining a wireless access locale for placing a wireless call using a wireless communication device as recited in claim 6 wherein said at least one data store also stores information relating to communication format accommodated by each said at least one wireless access signal.

8. A system for determining a wireless access locale for placing a wireless emergency service call using a wireless communication device; the system comprising:
(a) a signal sensing unit coupled with said wireless communication device for periodically sensing strength of a at least one wireless access signal detected by said wireless communication device;
(b) a location indicating unit coupled with at least one of said signal sensing unit and said wireless communication device for indicating location of said wireless communication device while said wireless communication device is
(c) at least one data store coupled with at least one of said signal sensing unit, said wireless communication device and said location indicating unit for storing at least signal strength information from said signal sensing unit and location indicating information from said location indicating unit for said at least one wireless access signal detected by said wireless communication device; and
(d) a mapping unit coupled with at least one of said data store and said wireless communication device; said mapping unit cooperating with said data store and said wireless communication device to indicate to a user of said wireless communication device a direction to at least one respective wireless access signal of said at least one wireless access signal for effecting said wireless emergency service call.

9. The system for determining a wireless access locale for placing a wireless emergency service call using a wireless communication device as recited in claim 8 wherein said mapping unit indicates a direction and a distance to each said at least one respective wireless access signal.

10. The system for determining a wireless access locale for placing a wireless emergency service call using a wireless communication device as recited in claim 8 wherein said at least one data store also stores facilities location information regarding cellular towers and cell boundaries within a predetermined range of said wireless communication device.

11. The system for determining a a wireless access locale for placing a wireless emergency service call using a wireless communication device as recited in claim 10 wherein said facilities location information is downloaded to said at least one data store via said wireless communication device.

12. The system for determining a wireless access locale for placing a wireless emergency service call using a wireless communication device as recited in claim 8 wherein said at least one data store also stores information relating to communication format accommodated by each said at least one wireless access signal.

13. The system for determining a wireless access locale for placing a wireless emergency service call using a wireless communication device as recited in claim 9 wherein said at least one data store also stores facilities location information regarding cellular towers and cell boundaries within a predetermined range of said wireless communication device.

14. The system for determining a wireless access locale for placing a wireless emergency service call using a wireless communication device as recited in claim 13 wherein said at least one data store also stores information relating to communication format accommodated by each said at least one wireless access signal.

15. A method for determining a wireless access locale for placing a wireless call using a wireless communication device; the method comprising:
(a) in no particular order:
(1) providing a signal sensing unit coupled with said wireless communication device for sensing strength of at least one wireless access signal detected by said wireless communication device;
(2) providing a location indicating unit coupled with at least one of said signal sensing unit and said wireless communication device for indicating location of said wireless communication device while said wireless communication device is detecting said at least one wireless access signal;
(3) providing at least one data store coupled with at least one of said signal sensing unit, said wireless communication device and said location indicating unit for storing at least signal strength information from said signal sensing unit and location indicating information from said location indicating unit for said at least one wireless access signal detected by said wireless communication device; and
(4) providing a mapping unit coupled with at least one of said data store and said wireless communication device; and
(b) operating said mapping unit cooperatively with said data store and said wireless communication device to indicate to a user of said wireless communication device at least one direction toward at least one respective wireless access signal of said at least one wireless access signal for effecting wireless communication.

16. The method for determining a wireless access locale for placing a wireless call using a wireless communication device as recited in claim 15 wherein said mapping unit indicates direction and distance to each said at least one respective wireless access signal.

17. The method for determining a wireless access locale for placing a wireless call using a wireless communication device as recited in claim 15 wherein said at least one data store also stores facilities location information regarding cellular towers and cell boundaries within a predetermined range of said wireless communication device.

18. The method for determining a wireless access locale for placing a wireless call using a wireless communication device as recited in claim 17 wherein said facilities location information is downloaded to said at least one data store via said wireless communication device.

19. The method for determining a wireless access locale for placing a wireless call using a wireless communication device as recited in claim 15 wherein said at least one data store also stores information relating to communication format accommodated by each said at least one wireless access signal.

20. The method for determining a wireless access locale for placing a wireless call using a wireless communication device as recited in claim 16 wherein said at least one data store also stores facilities location information regarding cellular towers and cell boundaries within a predetermined range of said wireless communication device, and wherein said at least one data store also stores information relating to communication format accommodated by each said at least one wireless access signal.
